(19) United States
(12) Patent Application Publication
(10) Pub. No.: US 2009/0307102 A1
(43) Pub. Date: Dec. 10, 2009

(54) System and method for providing donations

(75) Inventor: Elliot S. Goldman, Fort Worth, TX (US)

Correspondence Address: RG & ASSOCIATES, 1103 TWIN CREEKS, STE. 120, ALLEN, TX, 75013, US

(73) Assignee: GL2Partners, Fort Worth, TX (US)

(21) Appl. No.: 12/156,677

(22) Filed: Jun. 4, 2008

(51) Int. Cl. G06Q 40/00; G06Q 30/00; G06Q 20/00

(52) U.S. Cl. 705/26; 705/35; 705/39; 705/44

(57) ABSTRACT

A donation certificate and redemption system allows a donor to generate donation certificates that can be used by the donor or gifted to redeemers. The donation certificate includes a donation amount and a list of charities that can be selected by the redeemer. At redemption of the donation certificate, the redeemer nominates the charity and initiates a transfer of the donation amount, either from a donor account or a holding account, to an account of the nominated charity.

### FIELD OF THE DISCLOSURE

This disclosure relates to a system and method for providing donations to charities and in particular to providing charity donations on behalf of third parties.

### BACKGROUND OF THE DISCLOSURE

It has become common for charity donations to be given as gifts. In such an arrangement, a gifter makes a donation to a charity on behalf of a giftee. For example, a corporation may donate money on behalf of their employees to worthwhile charities.

A problem with this arrangement is that one donation is made by the corporation, without any recognition being provided to the individual employee and without any direction from the individual employee on whose behalf the donation is made. Likewise, an individual can directly support a charity or other entity with a donation but often times the process of finding a number of proper charities and donating to those charities is a very time consuming process.

Other problems exist. For example, a person or giftee cannot currently split various monetary amounts (or donations) amongst different agencies or certain projects run by or related to a charitable organization (or charity) based on a single donated amount. Thus, a weighting of a donation is not possible. Further, it is not possible to currently control which specific agencies or projects (out of a larger number of agencies or projects) should be the recipient of the monetary amount provided by the giftee.

Still further problems exist. For example, a gifter lacks any control over unredeemed donations and there is no mechanism for the gifter to control what amount of the unredeemed donations can be directed, for example, to any charity in any denomination. The gifter also currently lacks control in providing unredeemed donations by choosing specific agencies or projects run by or related to a single charitable organization.

Additional problems relate to a point of purchase or activation of an element, such as a gift card, which is related to a certain monetary amount. An entity, operating a web site, for example, does not current have the ability to track such an element across the distributor of the element and to pay a commission to the distributor based on the number of elements that the distributor has sold or activated.

Further problems relate to the fact that current elements are not issued in very low denominations (for example, a few cents to a few dollars). As such, an entity operating a web site, for example, is not able to drive traffic to their site by giving away the elements.

Therefore, what is needed is a system and method that overcomes these problems.

### SUMMARY OF THE DISCLOSURE

In accordance with one aspect of the disclosure, there -is provided a donation system comprising a donation certificate generation system, a donation certificate redemption system, and at least one electronic commerce engine. The donation certificate generation system allows a donor to generate at least one donation certificate in respect of at least one donation amount and in respect of at least one redeemer. The at least one donation certificate indicates one or more charities. The donation certificate redemption system allows a redeemer to redeem the at least one donation certificate and the electronic commerce engine transfers the at least one donation amount from a donor account to a charity account.

In accordance with one aspect of the disclosure, there is provided a method for providing a donation comprising indicating one or more redeemers, indicating a donation amount in respect of each of the one or more redeemers, indicating one or more charities in respect of each of the one or more redeemers, generating a donation certificate in respect of each of the one or more redeemers, each donation certificate comprising the respective donation amount and the respective indication of one or more charities, and providing each donation certificate to each respective redeemer.

In accordance with one aspect of the disclosure, there is provided a method for redeeming a donation certificate comprising receiving a donation certificate identity, receiving a nomination of one or more charities, and transferring a donation amount associated with the donation certificate identity to one or more charity accounts associated with the one or more charities.

In accordance with one aspect of the disclosure, there is provided a system for donating money. In the system, a database stores a list of charities. An interface allows a user to select at least one charity from the list of charities and nominate a donation amount. An electronic commerce engine transfers the donation amount to the at least one charity.

### BRIEF DESCRIPTION OF THE DRAWINGS

The invention will now be described, by way of example only, with reference to specific embodiments and to the accompanying drawings in which:

FIG. 1 schematically illustrates a donation generation and redemption system;

FIG. 2 illustrates a method for generating a donation certificate;

FIG. 3 illustrates an example of a donation certificate;

FIG. 4 illustrates a method for redeeming a donation certificate;

FIG. 5 schematically illustrates a webpage of a donation system;

FIG. 6 illustrates a donation card activation process;

FIG. 7 illustrates a donation card purchasing process;

FIG. 8 schematically illustrates an online donation shopping page; and

FIG. 9 illustrates a donation shopping process.

### DETAILED DESCRIPTION OF THE DISCLOSURE

The present disclosure provides a charitable donation certificate that can be used to provide a donation to one or more charities.

The donation certificate is related to a monetary value and may be a functional piece of physical paper or an electronic version of such a paper that can be given to or created by a person that could use it to donate to one or more charities. In either case, the donation certificate is associated with a donation certificate record in a system database. In one embodiment, the donation certificate may be a card that can be charged with a monetary amount and then used to make donations to charities. In other embodiments, the donation certificate may be a gift certificate, a gift card, etc. that can be formed in various shapes and sizes and include various themes based on the charity's mission, a religious event, a holiday, a birthday, and the like.

The donation certificate may be a gift certificate that is purchased on behalf of a person so that person (and not the person who purchased the gift certificate) can choose one or more charities that would receive all or a portion of the gift certificate amount. The gift certificate, which can be in any currency and denomination, is redeemable at a web site that lists the charities and accepts the gift certificates on behalf of the charities. The use of the certificate via the web site gets the users engaged with the site and allows for tracking of the use of the certificates. For example, corporations could buy the gift certificates in bulk and put them in their holiday cards for the recipients to donate on behalf of the corporation or on their own behalf.

In one embodiment, a person or giftee can currently split various monetary amounts (or donations) amongst different agencies or certain projects run by or related to a charitable organization (or charity) based on a single donated amount (associated with a single donation certificate). Thus, a weighting of a donation is possible. Further, it is possible to control which specific agencies or projects (out of a larger number of agencies or projects) should be the recipient of the monetary amount provided by the giftee.

In another embodiment, a gifter will have control over unredeemed donations and there is a mechanism for the gifter to control what amount of the unredeemed donations can be directed, for example, to any charity in any denomination. The gifter will have control in providing unredeemed donations by choosing specific agencies or projects run by or related to a single charitable organization that would receive such unredeemed donations.

In a point of purchase or activation of a donation certificate, an entity, operating a web site, for example, will have the ability to track such a donation certificate across the distributor of the donation certificate and to pay a commission to the distributor based on the number of donation certificates that the distributor has sold or activated. A unique or a common identifier can be used to identify the donation certificate(s) and/or the distributor. Various organizations (such as churches) will be more apt and motivated to become a distributor if monies are being provided to charitable organizations and if the organization can raise its own funds via the distribution of the donation certificates.

In an further embodiment, donation certificates can be issued in very low denominations (for example, a few cents to a few dollars). As such, an entity operating a web site, for example, is able to drive traffic to their site by giving away the donation certificates. If the donation certificates are used (i.e., the recipient accesses the web site to make a donation based on the low denomination) the web site increases its traffic and awareness at a low cost to the web site operator, and if the donation certificates are not used (i.e., the recipient does not access the web site), the monetary amount associated with the donation certificates is not used and thus not incurred by the web site operator.

The current disclosure can be used in a for-profit model whereby the result of creating charitable gift certificates allows a company to have significantly more effect at driving traffic to their web site or to a web site of their affiliates, increases donations, increases donation frequency, makes it easier to do promotions, captures more demographic information, reduces processing costs for an organization because personal information is input into the web site by an individual, increases sponsorship opportunities. Because the gift certificate gives a person the ability to make an autonomous choice, it gets them more engaged and will increase the likelihood of participation in the program. Multiple charity programs would allow choice and provide the gift certificate with a unique feature. Also, the gift certificate company that sold these certificates to companies to distribute could collect a fracture rate in order to generate revenue on any unused but redeemable certificates.

The gift certificate has broad reaching societal value, generates more donations and therefore more benefit for the charities and more profit for the coordinating entity. The gift certificates can be used on the web site, via direct mail (by mailing the certificate to the company that would then provide the applicable amount to the chosen charity), or by phone call (by verbalizing the certificate amount to the company that would then provide the applicable amount to the chosen charity).

Through the use of the gift certificates, promotions are more valuable because unlike other mediums, such as a catalog that can be thrown away, a gift certificate is an item that is typically kept and redeemed. Further, once at the point of redemption, the donor can increase the amount or receive further information about the chosen charity or other related charities in their communities or around the world.

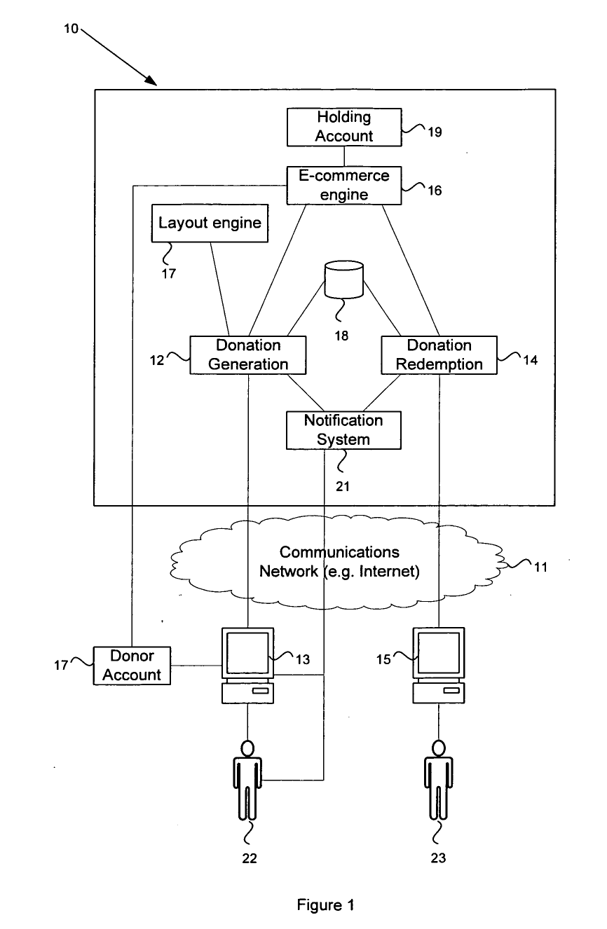

In FIG. 1, there is shown a donation generation and redemption system 10. The system 10 includes a donation certificate generation system 12, a donation certificate redemption system 14, an electronic commerce (e-commerce) engine 16 and at least one database 18. The donation certificate generation system 12 and the donation certificate redemption system 14 may be provided as servers, which may include appropriate processors and memories. While the donation certificate generation system 12 and the donation certificate redemption system 14 are shown individually, a person skilled in the art will understand that the functions of the donation certificate generation system 14 and the donation certificate redemption system 16 may be combined, for example by providing a single server. Access to the donation certificate generation system 12 and the donation certificate redemption system 14 may be provided as a website through a suitable telecommunications network 11, such as the internet, via interfaces 13, 15.

In one embodiment, the interface 13 may be a graphical user interface provided on a suitable computer device. The interface 13 may communicate with the donation certificate generation system 12 through a communications system 11 such as the internet or file transfer protocol (FTP). The donation certificate generation system 12 may operate as a web site that when accessed through the interface 13 allows a user to generate a donation certificate. In one embodiment, the donation certificate generation system 12 provides a website with online forms having fields that prompt a user for information.

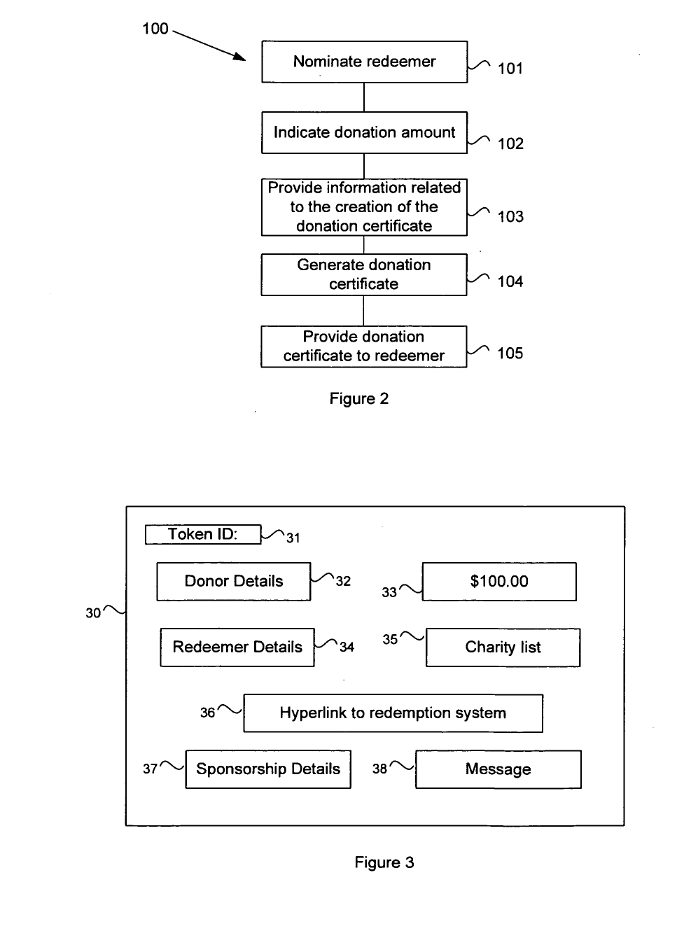

A method for generating a donation certificate will now be described with reference to the flowchart 100 of FIG. 2. At step 101, a user 22, who may be a donor, nominates a redeemer. The user then specifies a donation amount (step 102). At step 103, information related to the creation of the donation certificate (or gift certificate) is provided such as nominating one or more charities by the donor, how to process unredeemed gift certificates, and thee like. At step 104, the donation certificate is generated using the information provided. The donation certificate is then provided to the redeemer (step 105) who may then redeem the certificate at a time of their choosing, as will be described below.

In one embodiment, the database 18 stores a catalogue of available donation recipients. Though the donation recipients are referred to herein as charities, the donation recipients may or may not all be registered charities with registered tax deductibility status. When the user creates a donation certificate, the user may restrict the charity to a single charity, a group of charities or may leave the possible donation recipient unrestricted. The interface 13 may allow the user 22 to select charities for example, using a drop down menu, a check box system, or any suitable selection mechanism. The nomination of charities is used when the donation certificate is redeemed, as will be described below. In one embodiment, the user may indicate that a particular charity is preferred, but not restrict the donation certificate to redemption only with that charity. For example, an employer in providing gift donation certificates to employees, may indicate that a particular charity is endorsed by the employer, without restricting the employees to that endorsed charity when redeeming donation certificates. Further, the employer can direct unredeemed gift certificates to one or more entities of their choosing.

The system 10 may include a layout engine 17. In one embodiment, the layout engine designs a certificate in accordance with stored templates using the information provided by the user 22 such as details of the donor, selectable charities, details of the redeemer, personal or seasonal greetings etc. In addition, advertising, sponsorship information, legal or tax notices, and details of the system provider may also be provided. In an alternative embodiment, the layout engine 17 may allow the user 22 to create their own donation certificate format, ensuring that all essential information is incorporated.

Once all information has been provided, the layout engine 17 formats all of the required information and generates a donation certificate, including a certificate identification (ID) that is incorporated into the donation certificate. In one embodiment, the donation certificate may be tangible, i.e. a paper certificate, which may be printed and provided to the redeemer 23, e.g. by mail or by sending to an office of the donor for distribution. In one embodiment, the donation certificate may be intangible, i.e. existing only in an electronic form, and may be provided to the redeemer via electronic communication such as by electronic mail direct to the redeemer or to the donor for subsequent forwarding to the redeemer. The donation certificate may be provided as an image file, such as a jpeg, bitmap, PDF. The donation certificate may also be provided as HTML code. In one embodiment, the donation certificate may be provided to the redeemer as a hyperlink to the donation certificate stored in the system 10 that can be accessed and viewed by the redeemer through the donation certificate redemption system.

Address fields may be provided in the interface 13 that allow the system to receive address information used for supplying the donation certificates to the redeemer, directly to the redeemer, via the donor or by other means.

An example donation certificate 30 is depicted in FIG. 3. The donation certificate 30 includes a certificate ID 31, donor details 32, donation amount 33, and redeemer details 34. The donation certificate 30 also includes a list of charities 35 to which the donation amount may be donated when the donation certificate is redeemed. The list of charities may indicate a particular endorsed charity even though the donation certificate is not restricted to the endorsed charity. In one embodiment, the donation certificate 30 may be in the form of a certificate, and may be of any suitable size, such as A4, postcard size, etc. The donation certificate 30 may also include a link or a hyperlink 36 to a donation certificate redemption system. The donation certificate 30 may also include sponsorship details 37 (which may include a name, logo, contact information, and the like) for a third-party sponsor that may or may not be related to the charity, the web site operator, the gifter or the giftee, a message 38 from the the charity, the web site operator, the gifter or the giftee. It is important to note that the placement and size of the various areas 31-38 can be altered in any manner and that one or more of the areas can be removed or combined without departing from the scope of the present invention.

When the donation certificate is generated, details of the donation certificate are stored in a database 18 using the certificate ID as a primary key. Stored details may include an image of the donation certificate, as well as the details of the donor, redeemer, donation amount and any restrictions on the certificate, such as the charities nominated by the donor. Stored details may further include information related to a distribution entity that can be paid a monetary commission based on the number of donation certificates they sell or activate.

While the generation of a single donation certificate to a single redeemer has been described, the interface 13 may allow the user 22 to generate multiple donation certificates simultaneously. For example, the user 22 may specify a total donation amount and a number of donation certificates to be generated. The user may then specify redeemers for each donation certificate. Restrictions on charities may be nominated individually or collectively. The multiple donation certificates may then be generated, stored and distributed as described for the single donation certificate generation process described above, with the total donation amount divided amongst the multiple donation certificates.

With reference again to FIG. 1, when a donation certificate is generated, the user may provide details of a donor account 17, credit card or other funds transfer facility from which donations may be deducted by the e-commerce engine 16. The system 10 includes a system account 19, which may include a holding account, such as a trust. The electronic commerce engine 16 may be configured to transfer funds from the donor account to the holding account when the donation certificate is created. The amount of the fund transfer may include the total donation amount as well as any administration fee. Amounts for the donation may be held in trust until a redeemer 23 redeems the donation certificate.

The interface 15 may be a graphical user interface provided on a suitable computer device. The interface 15 may communicate with the donation certificate redemption system 14 through a suitable communications system 11 such as the internet or file transfer protocol (FTP). The donation certificate redemption system 14 may operate as a web site, providing a mechanism through the interface 15 for a user to redeem a donation certificate.

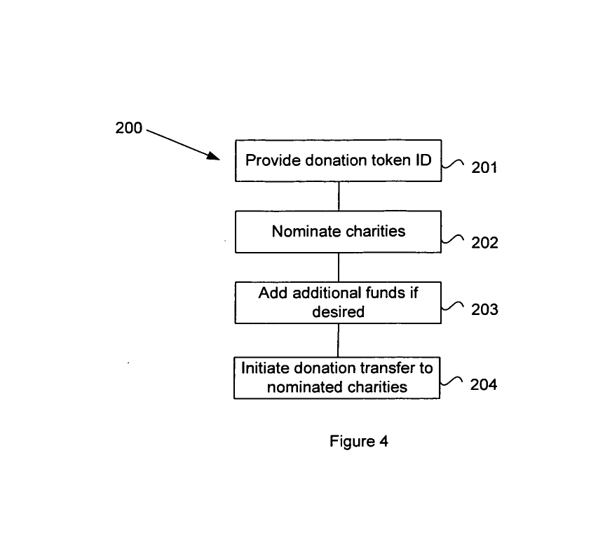

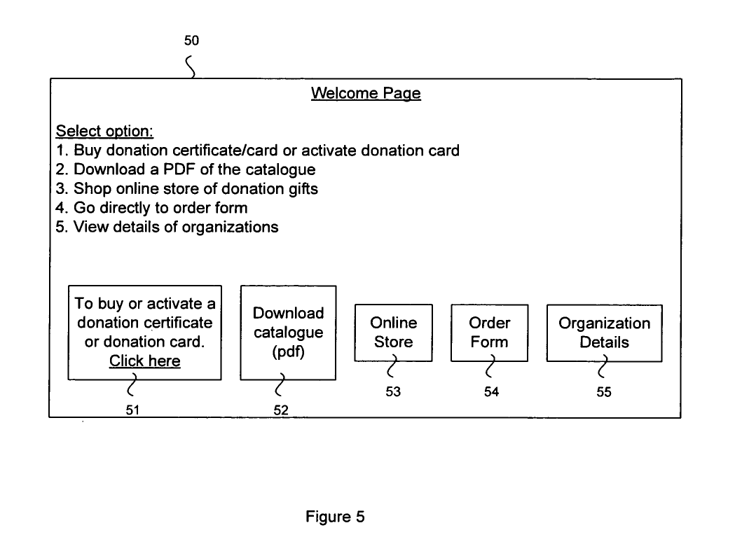

A method for redeeming a donation certificate will now be described with reference to FIG. 1 and to the flowchart 200 of FIG. 4. A redeemer 23 accesses the donation certificate redemption system 14 through the interface 15. In one embodiment, the interface 15 is a graphical user interface. The donation certificate redemption system 14 may provide a website that can be displayed on the interface 15 and that provides an online form that prompts the redeemer 23 for information. At step 201, the redeemer provides a certificate ID or otherwise identifies a donation certificate to the donation certificate redemption system. The donation certificate redemption system 14 uses the certificate ID to retrieve details of the donation certificate from the database 18, including a donation amount and any restrictions on the donation certificate. At step 202, the redeemer 23 nominates one or more charities, adds additional funds if desired (step 203) and then initiates a transfer of the donation amount of the donation certificate to the accounts of the nominated charities (step 204).

In one embodiment, the donation certificate redemption system 14 requests further information from the redeemer 23 to confirm the identity of the redeemer 23 and authorize the redeemer 23 to redeem the donation certificate. Information that may be used to authorize the redeemer may include personal details of the redeemer, a security code or password, or any suitable security information.

The charities may be selected from a drop down menu. The menu entries may be limited to only those charities provided within the restrictions of the donation certificate. Alternatively, all charities may be listed, but charities that are not able to be selected may be differently indicated, e.g. ghosted out, and inactive so that the redeemer is unable to select them. In one embodiment, the donation certificate redemption system 14 provides a search facility through the interface 15 that allows the redeemer 23 to search the database 18 for available charities to which donations may be made. The donation certificate redemption system 14 may be configured to allow only a single charity to be selected for redemption. In an alternative embodiment, the donation certificate redemption system may be configured to allow multiple charities to be selected within the limits specified by the user or donor that generated the donation certificate. Where the redeemer selects multiple charities, the redeemer may divide the donation amount equally between all the selected charities or may indicate specific amounts to each selected charity up to the total of the donation amount. The giftee can add additional monies to increase the donation amount using a check, credit card, on-line payment system, and the like,

If the donation certificate is unrestricted with respect to the selectable charities, the donation certificate redemption system may provide a search facility allowing the redeemer to search for charities based on various criteria, such as name, type of charity, location of charity, etc.

The transfer of the donation amount is enacted by the e-commerce engine 16. If a single charity has been selected by the redeemer, the e-commerce engine 16 and/or the donation certificate redemption system 14 looks up account details for the charity in the database 18. The e-commerce engine 16 then transfers the donation amount from the holding account 19 to the retrieved charity account. If multiple charities have been selected, account details for each charity are retrieved and the e-commerce engine transfers the donation amounts allocated to each charity by the redeemer to the respective charity accounts.

In one embodiment, a donation redemption website may allow a redeemer to indicate whether the redeemer desires to donate more than the donation amount of the donation certificate. If the redeemer selects an additional donation option, the donor is prompted for account details, a credit card number or similar and the e-commerce engine 16 initiates an appropriate transfer of funds from the redeemer account to the charity account. The transfer of funds from the redeemer may or may not pass through the holding account 19 of the system 10.

During redemption of the donation certificate, the redeemer may be provided with a statement indicating a tax status of the donation. In one embodiment, the redeemer may be advised that the redeemer is not entitled to the tax deduction because the donation was, according to relevant tax law, providing by the donor. However, if the redeemer has made an additional donation, the redeemer may by advised of the tax deductibility of the redeemer's contribution. The tax related statement may be provided to the redeemer directly through the interface 15, e.g. as a web page, or may be emailed to the redeemer using contact details provided by the redeemer.

In one embodiment, when a donation certificate is redeemed, a notification may be sent to the donor informing the donor of the redemption. The notification may indicate the one or more charities selected by the redeemer which may assist the donor in targeting future donation gifts for the redeemer. The notification may also indicate a date of the donation, with any applicable tax related information that allows the donor to properly account for the donation in tax statements. In one embodiment, the notification system automatically generates the notification, for example by generating and sending an email to the donor using an email address associated with the donor in the database 18. Other methods of generating and sending the notification to the donor will be apparent to the person skilled in the art.

To aid in selection of charities by either the donor/user 22 or redeemer 23, a catalogue of charities may be provided and either displayed through the interfaces 13, 15 or provided in a printed form. The catalogue may specify available charities, including information about the charity, such as type of charity, area that the charity services, affiliations (e.g. religious, political), type of work (e.g. working with homeless, disaster aid, animal welfare), current projects etc. The information may also include taxation status of the charity indicating whether donations are tax deductible.

While a single database 18 is shown, the person skilled in the art will understand that multiple databases may be provided. The database(s) may be co-located with one or more servers of the donation certificate generation system 12 and/or donation certificate redemption system 14 or may be provided in a distributed manner. The databases may be accessed through the servers only, or may be accessed directly by the user 22 and/or redeemer 23 through the communications network 11.

The donor may be an individual, group, organization or corporate entity such as a company. Similarly, the redeemer may be an individual, group, organization or corporate entity.

In many cases, the act of donating money creates a tax deduction for the donor and/or the redeemer. In various embodiments and in various taxation systems, a donation may be considered to be made when the donation certificate is generated, when funds are transferred from the donor account 17 to the system account 19 or when a donation certificate is redeemed. The database 18 may store information on the charity status of each charity available within the system. Thus, when a donation is made, the system determines the tax deductibility of the donation and issues the donor with tax donation information. The tax donation information may be provided through the notification system 21 using means such as electronic mail or direct mail. In one embodiment, tax donation information may be provided in an electronic form with fields allowing the tax donation details to be easily imported into a financial database.

If all charities indicated in a donation certificate have equal charity status, then the tax donation information may be provided to the donor at the time of issuing the donation certificate to the redeemer. Alternatively, the tax donation information may be provided to the donor when specific charities are selected at the time of redemption.

Providing the tax donation information at the time of generation of the certificate may create an obligation for the donation certificate to be redeemed within definite time period such as within the current financial year. Thus, in one embodiment, donation certificates may be generated with information including a redemption expiration deadline.

In the above described embodiments, donation amounts are transferred from a donor account 17 to the system holding account 19 at the time that the donation certificate is generated. In an alternative embodiment, the e-commerce engine 16 may be configured to transfer funds from the donor account 17 to a charity account (not shown) at the time of redemption, thus obviating the requirement for a holding account 19. Administration fees may still be transferred to a system account at the time of generating the donation certificate(s), or at the time of redemption.

An issue with the gift certificate system may be that redeemers do not redeem their donation gift certificates. In one embodiment, a gift certificate may specify an expiration time and a default charity may be specified by the donor. If a redeemer does not redeem the gift certificate within the expiration time, the system enacts the ecommerce engine to make the donation to the default charity. Triggering of the default donation may be made by executing a query on the database to establish any expired gift certificates. Default charity details associated with the expired gift certificate may then be retrieved from the database and passed to the ecommerce engine.

In one embodiment, donation certificates are offered through a distribution system including a network of agents, which may be, for example, newsagents, retail phone outlets, specialized donation certificate outlets, etc. A donation certificate may be generated by the distributor based on details such as donation amount, charity etc specified by the purchaser. The donation certificate may include an identification number that identifies the distributor to the system. The distributor may therefore receive an agency fee, royalty or commission from the system for providing donation certificates to donors. In one embodiment, the distributing entity may provide donation cards that can be charged at the distribution outlet by receiving money from the donor that the distributing entity then transfers to the system account. The donation cards may include an identifier, associated with a system record, that allows the holder of the card to make the donations through a website as will be described in greater detail below. The donation cards may be renewed and replenished at any distribution outlet, through a web site, via mail or a telephone.

A particular example will now be described with reference to FIGS. 5 to 9. In FIG. 5, there is shown a schematic layout of a webpage 50 providing a welcome page to a donation certificate system in accordance with an embodiment of the present disclosure. The welcome page 50 provides instructions for creating, purchasing and/or activating a donation certificate. For example, a user of the system may be provided with options to buy or activate a donation certificate 51, download a catalogue 52, e.g. in PDF format, shop using an online store format 53, shop using an order form 54, or view details 55 of the various organizations available through the donation system.

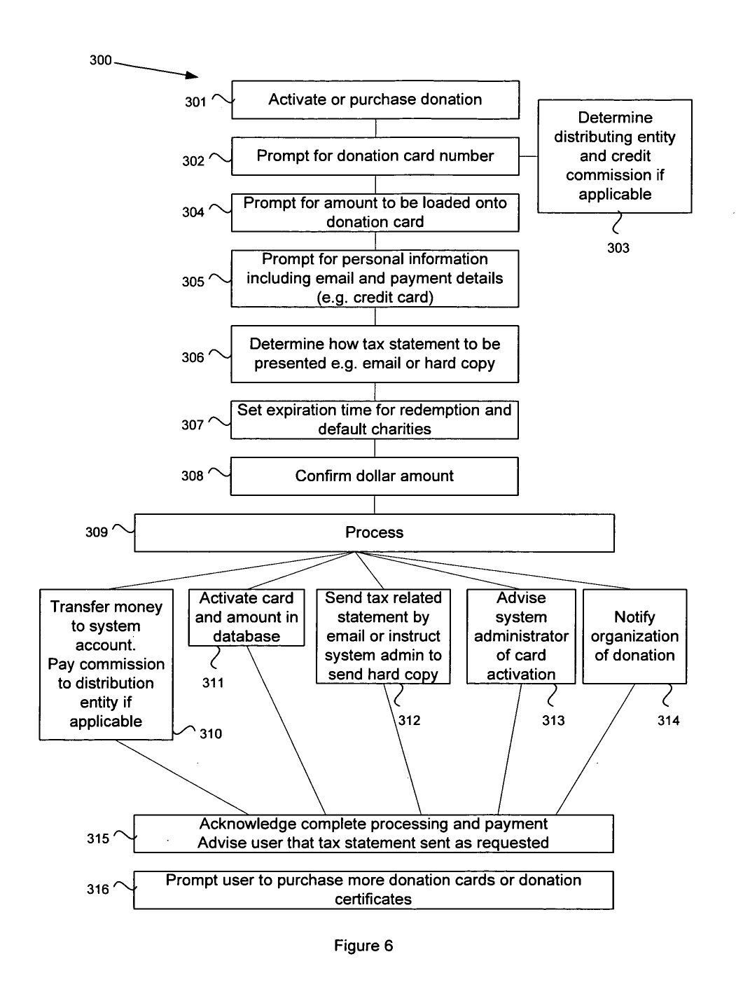

If the user selects option 51, the user is then taken to an activation process 300 shown in FIG. 6, an initial step of which is to ask the user if the user wishes to activate an existing donation card or purchase a new donation card or donation certificate. The activation process 300 is used where a donor or other user has collected a donation card and wishes to load it with money. The activation process may also be used by a distributing entity at the point of sale of a donation card to a donor. A separate purchasing process for donors will be described subsequently.

At step 302 of the activation process, a user is prompted to enter a donation card number. The donation card number identifies the distributing entity (step 303) that provided the donation card to the user. In various embodiments, the distributing entity may be entitled to an agency fee, royalty or similar commission. If the gift card purchase was motivated via a gift catalog, then the distributing entity of the gift catalog (with a distribution identification number) would be paid a commission.

At step 304, the webpage prompts the user to enter a monetary amount that is to be loaded onto the donation card. The user is then prompted to enter personal information 305 including an email address and payment information such as a direct debit account or credit card information. The user is then asked to specify how they wish to receive a tax information statement (step 306). The user may specify an electronic copy, e.g. by email or a hard copy provided by regular mail. An expiration time is then established and the user specifies a default charity to which the donation is made in the event that the donation card is not redeemed before expiring (step 307).

The user confirms the dollar amount at step 308 and then processing 309 commences. In processing, payment is transferred from the account specified by the user to a system account and if applicable, a royalty to the distributing entity is logged (step 310). Processing 310 also includes activating the card by establishing a record in the database that identifies the donation card number in association with the monetary value available on the card (step 311). A tax statement is sent to the user at step 312, either by email or by instructing the system administrator to send a hard copy by mail depending on the preferences indicated by the user. The system administrator is also advised of the card activation (step 313) including the amount transferred, card number, etc., and the organization is notified of the donation (step 314).

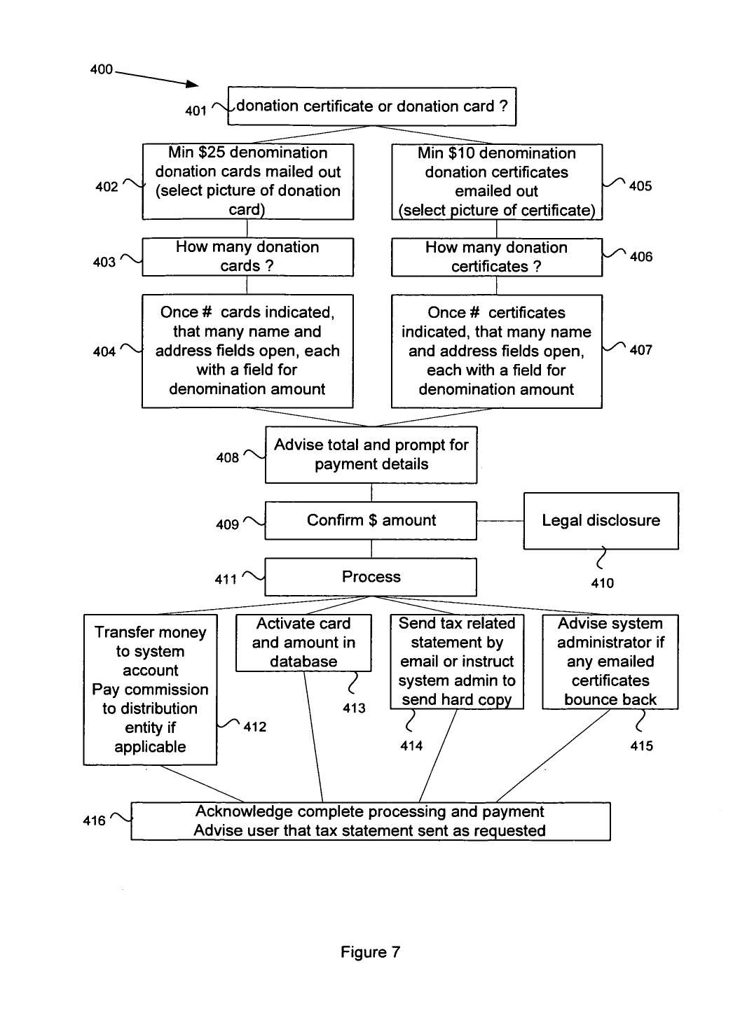

Once processing is complete, acknowledgement is made 315 including advising the user that a tax statement is being sent. The user is then asked if they wish to activate further donation cards or purchase new donation cards or donation certificates (step 316). If the user opts to activate another donation card, the user is returned to the initial activation screen 300. If however, the user opts to purchase new donation cards and certificates, the user enters a purchasing process 400 depicted in FIG. 7. The user may also enter the purchasing process 400 at option 301 shown in FIG. 6.

At step 401 of the purchasing process 400, the user is asked if they are purchasing a donation certificate or a hard copy form of the certificate such as a donation card. If the user specifies a donation card, which is to be mailed, the user is advised of the minimum denomination amount (step 402) and asked to select the number of donation cards to be purchased (step 403) and a graphic for each donation card. Once the number of donation cards is indicated, that number of records open up to allow the user to enter redeemer details for each donation card (step 404). The redeemer details will include name, mailing address and a denomination amount for each donation card.

If the user selects donation certificates at option 401, the user is similarly advised of a minimum denomination amount for donation certificates (step 405) and prompted to select a number of donation certificate (step 406) and a graphic for the donation certificate. Once the number of donation certificates is indicated, that number of records open up to allow the user to enter redeemer details for each donation certificate (step 407). The redeemer details will include name, emailing address and a denomination amount for each donation certificate.

The process then continues by totaling the amounts of the donation cards and/or donation certificates at step 408 and indicating the total to the user who provides payment details. The value of the purchase is confirmed at step 409 together with any legal disclosure, such as tax related information (step 410). Processing then commences at step 411. As for the donation card activation process described previously, processing of the donation card or donation certificate purchase includes a transfer of money from the user specified account to a system account (step 412) including logging of commission to the distributing entity. Processing also includes activating the card/certificate in the system database 413 and sending tax statements 414. In addition, processing includes the system administrator creating and sending the donation certificates to the redeemers by email, including monitoring whether any emails to the redeemers bounce back (step 415).

If processing is successfully completed, acknowledgement of the completed processing is given to the user at step 416 and the user may return to the home page of the website or otherwise exit. The system then proceeds to produce the donation cards and mail the donation cards to the indicated redeemers.

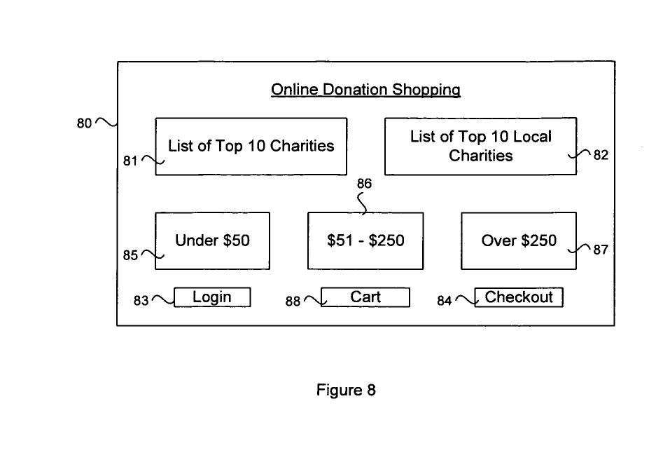

FIG. 8 schematically shows how an online store may be presented to a user. The online store allows a user to select a charity and to make a donation to that charity either anonymously, from themselves, or on behalf of another party such as a giftee, honoree or as a remembrance. An initial page 80 of an online store may present a list of top 10 charities 81, a list of top 10 local charities 82 and other elements such as a shopping cart 88, account logins 83, checkout 84 etc. Each charity listed may be provided as a hyperlink that when selected takes the user to a webpage providing more details of the selected charity. The hyperlinked page may be a summary page provided within the system or may be the home page of the respective charity. The online store page 80 may also include icons that allow a user to select different donation amounts, such as an icon 85 for donations under $50, an icon 86 for donations between $51 and $250 and an icon 87 for donations over $250. Icons representing standard amounts, e.g. $100 may also be provided.

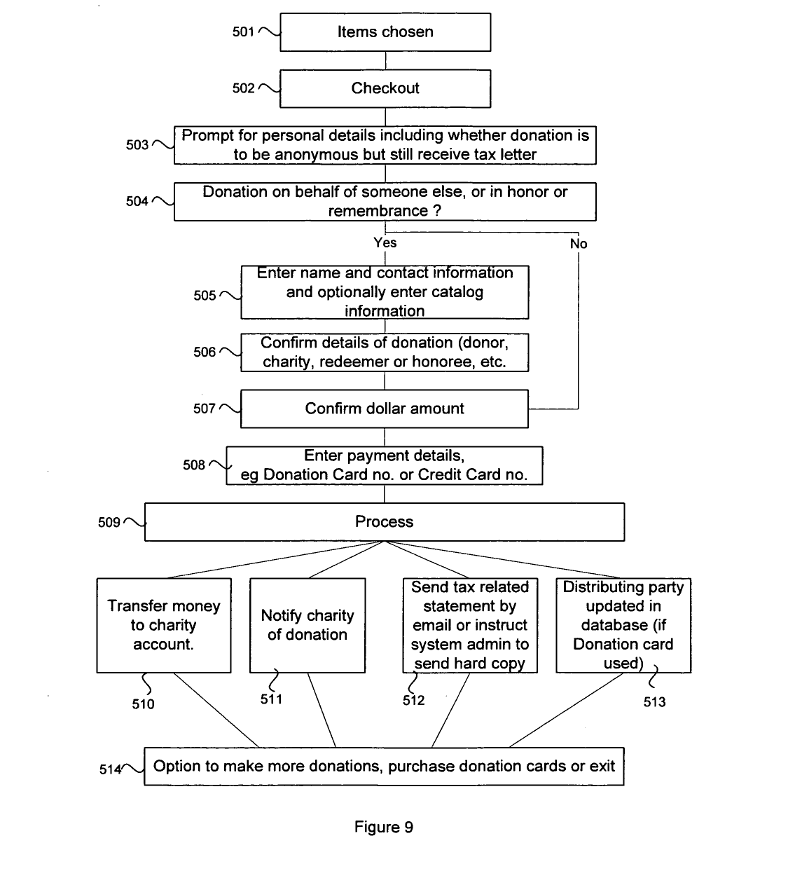

A process for online shopping presented through the web interface, including use of donation cards, will now be described with reference to FIG. 9. A user chooses items 501 using the webpage 80, such as by selecting a Top 10 charity from the list 81 and by selecting the icon 85 for a donation amount under $50. Once the items are chosen, the user proceeds at step 502 to a checkout by selecting icon 84. The user is prompted for personal details (step 503) and whether the donation is to be anonymously. At step 504, the user is asked whether they are making the donation themselves or on behalf of a third party. If the user selects an icon indicating a third party, the user is then prompted to enter personal details of the other party and to optionally enter catalog information (such as an identifier) if the user utilized such a medium (step 505). The system may be configured to send acknowledgements on behalf of the charities to the donors. Thus, the system may confirm all the details of the donation at step 506, including providing the user with a form acknowledgement and thank you that will be sent to the other party for providing the donation.

Whether the donation is being made by the user or by a third party, the process continues by prompting the user to confirm the donation amount 507 and enter payment details 508. Payment may be made by the user specifying a suitable account such as a credit card for processing by an ecommerce engine of the system. Alternatively, the user may specify a donation card number. If the user specifies a donation card number, the system accesses the donation card record in the database to determine if the donation card has sufficient current funds to meet the present donation amount.

The system then processes the donation at step 509. Processing includes transferring the donation amount to a charity account (step 510). The donation amount may be transferred from an account nominated by the user. If the user has indicated that the donation is to be made using a donation card, the transfer is made from a system account and the donation card record is updated to debit the donation amount from the donation card. Processing also includes notifying the charity of the donation 511. Where payment is provided from a user account, the user is issued with a tax statement 512. No tax statement is required when a donation card donation transaction is made if a tax statement has been provided at the time of charging money onto the donation card. If a donation card is used, the database is updated with details of the distributing entity 513. Once processing is complete, the user is provided with an option to select more donations, purchase donation cards and donation certificates or exit the system 514.

The online store system allows donors to quickly browse available charities, which may be categorized in a variety of ways such as local, most popular, etc, and to make donations using a donation card or by nominating an account.

An improvement of the above described embodiments over prior art systems of charity donation gifts includes that the giftee is provided with a degree of control over which charity receives their nominal donation. This is advantageous where the giftee, i.e. the redeemer, may have otherwise disagreed with the selection of a charity by the gifter. A further advantage is allowing the donor to specify a default charity to be used in the event that the donation gift has not been redeemed. Other advantages of the above described embodiment include providing an automated system for providing donations to multiple charities on behalf of third parties.

In one embodiment, a person or giftee can currently split various monetary amounts (or donations) amongst different agencies or certain projects run by or related to a charitable organization (or charity) based on a single donated amount (associated with a single donation certificate). Thus, a weighting of a donation is possible. Further, it is possible to control which specific agencies or projects (out of a larger number of agencies or projects) should be the recipient of the monetary amount provided by the giftee.

In another embodiment, a gifter will have control over unredeemed donations and there is a mechanism for the gifter to control what amount of the unredeemed donations can be directed, for example, to any charity in any denomination. The gifter will have control in providing unredeemed donations by choosing specific agencies or projects run by or related to a single charitable organization that would receive such unredeemed donations.

In a point of purchase or activation of a donation certificate, an entity, operating a web site, for example, will have the ability to track such a donation certificate across the distributor of the donation certificate and to pay a commission to the distributor based on the number of donation certificates that the distributor has sold or activated. A unique or a common identifier can be used to identify the donation certificate(s) and/or the distributor. Various organizations (such as churches) will be more apt and motivated to become a distributor if monies are being provided to charitable organizations and if the organization can raise its own funds via the distribution of the donation certificates.

In a further embodiment, donation certificates can be issued in very low denominations (for example, a few cents to a few dollars). As such, an entity operating a web site, for example, is able to drive traffic to their site by giving away the donation certificates. If the donation certificates are used (i.e., the recipient accesses the web site to make a donation based on the low denomination) the web site increases its traffic and awareness at a low cost to the web site operator, and if the donation certificates are not used (i.e., the recipient does not access the web site), the monetary amount associated with the donation certificates is not used and thus not incurred by the web site operator.

The current disclosure can be used in a for-profit model whereby the result of creating charitable gift certificates allows a company to have significantly more effect at driving traffic to their web site or to a web site of their affiliates, increases donations, increases donation frequency, makes it easier to do promotions, captures more demographic information, reduces processing costs for an organization because personal information is input into the web site by an individual, increases sponsorship opportunities. Because the gift certificate gives a person the ability to make an autonomous choice, it gets them more engaged and will increase the likelihood of participation in the program. Multiple charity programs would allow choice and provide the gift certificate with a unique feature. Also, the gift certificate company that sold these certificates to companies to distribute could collect a fracture rate in order to generate revenue on any unused but redeemable certificates.

The gift certificate has broad reaching societal value, generates more donations and therefore more benefit for the charities and more profit for the coordinating entity. The gift certificates can be used on the web site, via direct mail (by mailing the certificate to the company that would then provide the applicable amount to the chosen charity), or by phone call (by verbalizing the certificate amount to the company that would then provide the applicable amount to the chosen charity).

Through the use of the gift certificates, promotions are more valuable because unlike other mediums, such as a catalog that can be thrown away, a gift certificate is an item that is typically kept and redeemed. Further, once at the point of redemption, the donor can increase the amount or receive further information about the chosen charity or other related charities in their communities or around the world.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A donation system comprising:
a donation certificate generation system that allows a donor to generate at least one donation certificate in respect of at least one donation amount and in respect of at least one redeemer, the at least one donation certificate indicating one or more charities;
a donation certificate redemption system that allows a redeemer to redeem the at least one donation certificate; and
at least one electronic commerce engine that transfers the at least one donation amount from a donor account to a charity account.

2. The donation system according to claim 1 wherein the donation certificate generation system comprises an interface that allows a donor to specify the at least one donation amount and the at least one redeemer.

3. The donation system according to claim 2 wherein the donation certificate generation system allows the donor to generate multiple donation certificates, each donation certificate comprising a redeemer and a donation amount.

4. The donation system according to claim 1 wherein the donation certificate redemption system provides an interface that allows a redeemer to select at least one charity indicated in the at least one donation certificate.

5. The donation system according to claim 1 wherein the donation certificate redemption system allows a redeemer to indicate an additional donation amount to the at least one charity selected by the redeemer and wherein the electronic commerce engine transfers the additional donation amount from a redeemer account to a charity account.

6. The donation system according to claim 1 further comprising a notification system that notifies the donor of a redemption of the at least one donation certificate.

7. The donation system according to claim 6 wherein a notification to the donor comprises an indication of a charity selected by the redeemer.

8. The donation system according to claim 6 wherein a notification to the donor comprises an indication of a tax deductibility of the at least one donation amount.

9. The donation system according to claim 1 further comprising at least one database that stores a catalogue of charities.

10. A method for providing a donation comprising:
indicating one or more redeemers;
indicating a donation amount in respect of each of the one or more redeemers;
indicating one or more charities in respect of each of the one or more redeemers;
generating a donation certificate in respect of each of the one or more redeemers, each donation certificate comprising the respective donation amount and the respective indication of one or more charities; and
providing each donation certificate to each respective redeemer.

11. The method according to claim 10 further comprising transferring a financial donation amount from a donor account to a holding account.

12. The method according to claim 10 further comprising selecting the one or more charities from a catalogue of charities.

13. The method according to claim 10 wherein indicating one or more redeemers, indicating a donation amount and indicating one or more charities comprises utilizing one or more online forms.

14. The method according to claim 10 wherein generating a donation certificate comprises generating a donation certificate identity and storing the donation certificate in a database with the donation certificate identity.

15. The method according to claim 10 further comprising notifying a donor of a tax deductibility of the donation amount of at least one donation certificate.

16. The method according to claim 15 wherein the notifying occurs after the at least one donation certificate is redeemed, wherein the notifying is sent to at least one of:
the one or more charities;
the redeemer; and
a gifter.

17. A method for redeeming a donation certificate comprising:
receiving a donation certificate identity;
receiving a nomination of one or more charities; and
transferring a donation amount associated with the donation certificate identity to one or more charity accounts associated with the one or more charities.

18. The method according to claim 17 further comprising:
retrieving a donation certificate from a database using the donation certificate identity;
determining a donation amount of the donation certificate; and
determining one or more charities indicated by the donation certificate;
wherein receiving the nomination of one or more charities comprises receiving a nomination of at least one of the one or more charities indicated by the donation certificate.

19. The method according to claim 18 further comprising:
retrieving a charity account identity for a nominated charity from the database; and
transferring the donation amount from a holding account to a charity account indicated by the charity account identity.

20. The method according to claim 18 further comprising notifying a donor of the at least one nominated charities.

21. A system for donating money comprising:
at least one database that stores a list of charities;
an interface that allows a user to:
select at least one charity from the list of charities; and
nominate a donation amount; and
an electronic commerce engine that transfers the donation amount to the at least one charity.

22. The system according to claim 21 wherein the electronic commerce engine transfers the donation amount from a system account; wherein the interface further allows a user to indicate a donation certificate record; and
wherein the system is configured to:
retrieve the donation certificate record from the at least one database, the donation certificate record comprising a monetary amount;
deduct a transferred amount from the retrieved monetary amount; and
update the donation certification record to indicate the deduction.

23. The system according to claim 22 further configured to:
create the donation certificate record;
receive the monetary amount from a user account to the system account;
associate the transferred monetary amount with the donation certificate record;
generate a donation certificate; and
provide the donation certificate to a person indicated by the user.

24. The system according to claim 21 wherein the system is further configured to generate tax related information in respect of received monetary amount and provide the tax related information to the user.

25. The system according to claim 21 wherein the electronic commerce engine transfers the donation amount from a user account.
